(19) United States
(12) Patent Application Publication
(10) Pub. No.: US 2007/0287453 A1
(43) Pub. Date: Dec. 13, 2007

(54) Method for delivering customized multimedia greeting to calling party in communication network

(75) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/501,994

(22) Filed: Aug. 10, 2006

(30) Foreign Application Priority Data
Jun. 12, 2006 (CN) 200610091753.3

(51) Int. Cl. H04Q 7/20

(52) U.S. Cl. 455/435.1

(57) ABSTRACT

In a communication network, a user establishes a profile, which is stored on the network. The profile includes a default multimedia greeting and additional greetings, each associated with one or more communication identifiers listed in the profile, e.g., the identifiers are mobile phone numbers of persons who may contact the user. Each greeting is an executable data file configured to play on a mobile phone, computer, or other terminal, and may include audio and changing image multimedia content. In operation, when a calling party calls the user's terminal, the identifier of the calling party's terminal is cross-referenced to the profile. If the identifier is not in the profile, the default greeting is transmitted to the calling party from a network media server. If the identifier is in the profile, the greeting associated with the identifier is transmitted. The greeting is played until the user answers the communication.

This application is entitled to the benefit of and claims foreign priority under 35 U.S.C. §119 from Chinese Patent Application No. 200610091753.3, filed Jun. 12, 2006, the disclosure of which is hereby incorporated by reference.

### FIELD OF THE INVENTION

The present invention relates to communications and, more particularly, to user services for delivering content in a wireless network or other communication system.

### BACKGROUND OF THE INVENTION

Modern communication systems offer a number of different options for parties to communicate with one another over long distances. These include e-mail communications over computer networks such as the Internet, and direct, high-speed voice, video, and data communications using computer networks, circuit-switched, landline-based telecommunication networks (e.g., public switched telephone networks), and wireless communication networks. Because wireless units (e.g., mobile phones) have become more reliable, less expensive, and therefore very widespread in use, people send and receive communications more often than ever before. For example, throughout the day a typical mobile phone user might receive a number of communications, including voice calls and text messages from family members, business acquaintances, and unsolicited third parties.

Each time a communication is established between a “source” wireless unit (e.g., the mobile phone initiating communication) and a “recipient” wireless unit (e.g., the mobile phone being called), certain information is made available to the source user (e.g., the calling party) and to the recipient user (e.g., the party being called). For example, when a source user initiates a call, the communication identifier of the recipient wireless unit, such as the phone number of the mobile phone being called, is typically displayed on the source unit. Additionally, if it is available over the communication network, e.g., through a caller ID function, the communication identifier of the source unit may also be displayed on the recipient wireless unit. Along with this information, a status or alert indicator is typically initiated at each unit. For example, text similar to “Status: Calling . . . ” may be displayed on the source terminal, and a ring tone may be sounded on the recipient unit to alert the recipient user of an incoming communication. At the recipient unit, different ring tones may be assigned to different communication identifiers, so that a particular ring tone is sounded when a call is received from a particular wireless unit. This enables the recipient user to determine the source of the call without having to look at the user's wireless unit/phone. Additionally, some systems allow a caller to designate sounds for playing on his or her wireless unit when a call is initiated to certain wireless units. However, only audio clips or music can be played, and there is no way for a called party to designate or otherwise affect what types of sounds are played on calling wireless units.

### SUMMARY OF THE INVENTION

An embodiment of the present invention relates to a method for communicating with a terminal over a network, e.g., for delivering multimedia greeting messages or similar content. By “terminal” it is meant an electronic device capable of communicating with other devices over a network, including, for example, computers and wireless units such as mobile phones, wireless PDA's, wireless devices with high-speed data transfer capabilities, such as those compliant with “3-G” or “4-G” standards, “WiFi”-equipped computer terminals, and the like. According to the method, upon initiation of a communication from a first terminal to a second terminal, a communication identifier of the first terminal (e.g., an alphanumeric string or the like that identifies the terminal for communication purposes, such as a phone number, IP address, or e-mail address) is compared to a profile or other data record associated with the second terminal. Based on the comparison, executable data associated with the first terminal in the record may be transmitted to the first terminal. By “executable data” it is meant data that includes both content data (e.g., text, audio, and/or video) and an implied or explicit command for how the data is to be used. For example, the executable data may be a multimedia greeting that is automatically displayed/played on the first terminal. By “multimedia,” is it meant moving and/or still visual content data in combination with audio content data, and more typically moving/changing images and associated sound.

In another embodiment, the user of the second (recipient) terminal establishes the profile or other data record, which is stored on the second terminal or on the network. For example, the user could access a function provided for this purpose on the user's terminal, or the user could access a service on the network. The user lists a number of communication identifiers in the profile, which will typically be associated with terminals that are expected to initiate communications with the second terminal. For example, the communication identifiers may be the mobile phone numbers of wireless units used by the user's friends, family members, business associates, and other acquaintances. In the profile, the user assigns a multimedia greeting or other executable data to each communication identifier. The same greeting may be used for multiple identifiers, e.g., one greeting may be assigned to any category of communication identifiers, such as the user's business associates, and another to the user's friends and family. Thus, when the second/recipient terminal receives a call or other communication from another terminal, the communication identifier of the calling terminal is cross-referenced to the profile, for determining which greeting to transmit to the calling terminal. The greetings or other executable data may be selected and/or customized by the user of the recipient terminal, including uploading the greetings to the network for storage thereon.

In another embodiment, the greeting or other executable data is displayed or otherwise executed on the first terminal (e.g., the terminal initiating the communication) until the communication is answered at the second terminal. Thus, while the user of the first terminal waits for the user of the second terminal to answer the communication, the greeting or other executable is displayed for the first user.

In another embodiment, the profile or other data record of the recipient terminal is configured to include default executable data, which is not associated with a particular communication identifier. Instead, if the communication identifier of a first (source) terminal initiating communication with the second (recipient) terminal is not listed in the profile, the default executable data is transmitted to the first terminal. Thus, in this embodiment all terminals contacting the recipient terminal will receive a greeting, regardless of whether they are specifically listed in the profile.

In another embodiment, a number of profiles or other data records are stored on the network in a database or the like, each of which is for a different wireless unit or other terminal. Typically, each profile is linked to its respective terminal according to terminal communication identifier. Thus, when a first terminal initiates communication with a second terminal, it is determined if the communication identifier of the second terminal is listed in the database. For example, all the profiles may be searched, or there may be an index linking the communication identifiers to particular profiles. If not, the communication continues as normal. If so, the profile associated with the second terminal is accessed, and the communication identifier of the first terminal is cross-referenced to the profile, as described above.

### BRIEF DESCRIPTION OF THE DRAWINGS

The present invention will be better understood from reading the following description of non-limiting embodiments, with reference to the attached drawings, wherein below:

FIG. 1 is a schematic view of a system for delivering executable data to calling parties in a network, according to an embodiment of the present invention;

FIG. 2 is a schematic view of an alternative embodiment of a user profile portion of the system;

FIG. 3 is a schematic view of an Internet interface portion of the system;

FIG. 4 is a flowchart of an embodiment of a method carried out by the system in FIG. 1; and

FIG. 5 is a schematic view of one embodiment of a signaling scheme for implementing the system.

### DETAILED DESCRIPTION

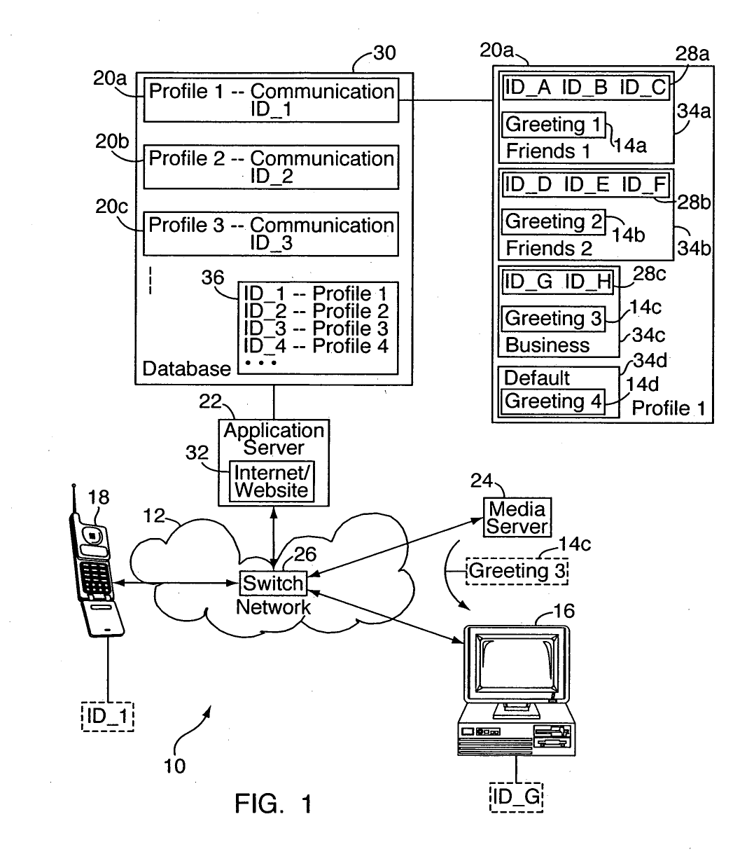

With reference to FIGS. 1-5, a system 10 is implemented on or as part of one or more communication networks 12 for delivering multimedia greetings or other executable data 14a-14d to source terminals 16, e.g., the greetings are transmitted to computer terminals, wireless units, or other terminals initiating communications to recipient terminals 18. (In other words, “source” terminal relates to the calling party, and “recipient” terminal to the party being called.) A user of a recipient terminal 18 establishes a greeting profile or other data record 20a, which may be stored on the network 12 along with the profiles 20b, 20c of other users. The profile 20a includes a default multimedia greeting 14d, and one or more additional greetings 14a-14c, each associated with one or more communication identifiers “ID_A”-“ID_H” listed in the profile 20a. The communication identifiers ID_A-ID_H may be, for example, mobile phone numbers associated with source terminals 16 (e.g., mobile phones) operated by persons likely to contact the user of the recipient terminal 18. Each greeting 14a-14d is an executable data set or file configured to play on a mobile phone, computer, or other terminal 16, 18, and may include audio, video, text, and/or other multimedia content. In operation, when a third party calls the recipient terminal 18 from a source terminal 16, the communication identifier of the source terminal 16 is cross-referenced to the profile 20a. (For example, as illustrated in FIG. 1, the identifier of the source terminal 16 is ID_G.) If the identifier ID_G is listed in the profile 20a, then the greeting 14c associated with the identifier ID_G in the profile 20a is transmitted to the source terminal 16. If the identifier ID_G were not listed in the profile 20a, then the default greeting 14d would be transmitted to the source terminal 16. In either case, the greeting 14c or 14d is typically played on the source terminal 16 until the communication is answered at the recipient terminal 18.

The system 10 of the present invention is suitable for implementation on various types of communication networks 12, including stand-alone networks and interconnected networks. For example, the network(s) 12 may include wire-line networks such as DSL networks, public switched telephone networks (PSTN), IP (Internet protocol)-based networks such as the Internet or other packet data networks, local area networks (LAN), and wireless networks such as those using CDMA, GSM, IEEE 802.11x, and/or UMTS communications or the like. As noted above, the terminals 16, 18 are electronic devices capable of communicating with one another over the network(s) 12, and may include, for example, computer terminals, wire-line connected communication devices such as conventional telephones and enhanced/multimedia-capable telephones, and/or wireless units such as mobile phones, wireless PDA's, wireless devices with high-speed data transfer capabilities, such as those compliant with “3-G” or “4-G” standards, “WiFi”-equipped computer terminals, and the like. The terminals 16, 18 communicate with one another over the networks 12 in a standard manner, depending on the particular networks and the particular types of terminals. For example, in the case of wireless units and a wireless network, the network may include one or more fixed base stations (not shown) having various transceivers and antennae for wireless, radio-frequency (RF) communications with the wireless units over one or more RF channels, in a manner based on the wireless communication method and protocol used. A radio network controller interconnects the base stations and performs the signaling functions necessary to establish calls and other data transfer to and from the wireless units. It also acts as the interface between the wireless/RF end of the network and the wire-line portion of the network and external wire-line networks. For example, a wireless network typically includes landline portions (e.g., a backbone connecting the base stations and radio network controller), and is typically connected to a PSTN and/or to an IP network, which allows the wireless units to communicate with terminals connected to the PSTN or IP network, such as landline phones and computer terminals.

As indicated in FIG. 1, the system 10 may include an application server terminal 22 and a media server terminal 24, both connected to the network(s) 12. For example, the application server 22 and media server 24 may be connected (directly or indirectly) to a network switch 26, e.g., one or more network components (such as a radio network controller, mobile switching center, data router, or the like) where message, call routing, and/or other communication functions are carried out. The application server 22 is provided for storing the profiles 20a-20c in a database 30. The application server 22 may also be configured to carry out one or more of the functions of the system 10, and may also include an Internet interface (e.g., website) 32 for users to establish, access, and configure their profiles 20a-20c from an Internet-connected terminal. The media server 24 is provided for streaming or otherwise transmitting the greetings 14a-14c to source terminals 16. The application server and media server may be existing components of the networks 12, each having a script, other software program, suite of software programs, and/or hardware or hardware/software module configured for implementing the system 10.

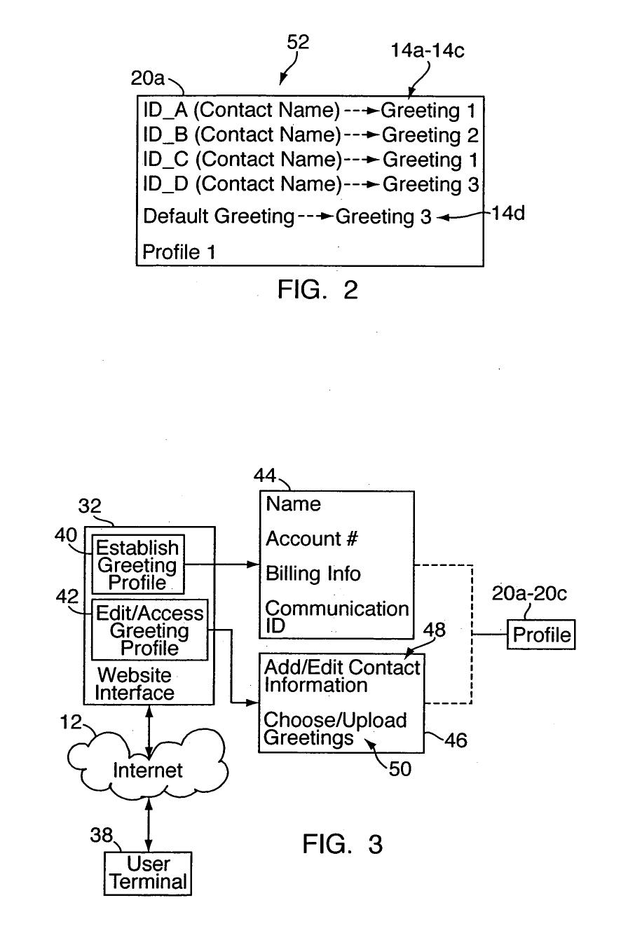

Typically, the functionality of the system 10 will be offered as a network service to users, either free or as a subscription service. In either case, interested users access the application server 22 to establish profiles 20a-20c. This may be done by accessing the application server's Internet interface 32, or by accessing another user interface provided for this purpose. For example, the user's terminal 18 could be provided with a hardware and/or software module acting as an interface to the application server. (In the case of a mobile phone the function could be accessible using the phone's menu system, with the phone and application server exchanging data for enabling the user to establish and configure a profile 20a-20c.) Upon accessing the Internet interface 32 or other interface, the user is provided with options for establishing a profile 20a, including subscription options if applicable. The profile 20a will typically include the communication identifier associated with the user's terminal 18, e.g., as shown in FIG. 1 the communication identifier of the terminal 18 is “ID_{—}1.” The profile may also include other user data such as name, account number, and the like. After establishing a profile 20a, the user populates the profile with the communication identifiers ID_A-ID_H of terminals 16 that may initiate communications with the user's terminal 18. For example, the communication identifiers may be associated with terminals 16 operated by the user's friends, family, business associates, and other acquaintances. The user then associates a greeting or other executable data 14a-14c with each communication identifier ID_A-ID_H. This may be done in a list-like manner, as shown in FIG. 2. Alternatively, as shown in FIG. 1, communication identifiers may be grouped together into categories 34a-34c, with each category having an associated greeting and a list 28a-28c of identifiers. For example, there may be different “friends” categories 34a, 34b with respective greetings 14a, 14b, a “family” category (not shown), and a “business” category 34c with a greeting 14c. The default may also be considered a category 34d. The system may be configured to allow the user to select the number of categories, and to customize the categories such as changing category names. Also, the profile may include additional information, such as the names 52 of persons associated with the identifiers ID_A-ID_H (see FIG. 2). The user also selects a default greeting 14d for the profile 20a.

As noted above, each greeting 14a-14d is an executable data set, stream, or file configured for automatic execution on a mobile phone, computer, or other terminal 16, 18. (As should be appreciated, to the extent the storage and/or transmission of a greeting is file-based, or otherwise, the greeting 14a-14c may include one file or several sub-files, e.g., a pictorial content file and an audio content file.) The executable data set will typically include both content data (which may include, e.g., multimedia data or other audio, video, pictorial, text, or other data) and an implied or explicit command for how the content data is to be automatically used once received at a source terminal 16. That is, there may be an actual command included with the content data, or the formatting and/or content of the executable data set may dictate the manner of its automatic execution. For example, in the case of a multimedia greeting, the visual content portion of the greeting is automatically displayed on the source terminal's display, and the audio content portion of the greeting, if any, is played over the terminal's speaker or other audio output means, typically concurrently with the data being received at the terminal. (In other words, for a greeting, it is typically the case that the greeting data will be streamed from the media server 24 to the source terminal 16 for execution as soon as the data is received, or possibly with a slight delay due to buffering. Other options include executing the data set/file once all the data is downloaded to the source terminal.) The system 10 may include a library of stock greetings for a user to select from and possibly modify or customize for the user's use, e.g., adding the user's name and/or picture. Alternatively, the system may be configured for a user to upload the user's own multimedia greetings or other executable data sets to the application server 22, in a standard manner. Upon being uploaded, the greetings are stored in the database 30 or in another location accessible to the application server 22 and/or media server 24, in association with the profile 20a-20c, e.g., the profile may include a link to each greeting such as a file name.

FIG. 3 shows a simplified example of the Internet/website interface 32. As indicated, the website 32 is accessible over the Internet 12 from an Internet-connected terminal 38, which may be recipient terminal 18 or another terminal, e.g., a home computer. The interface 32 includes (in addition to explanatory material, help functionality, and the like) an option 40 for establishing a profile 20a-20c, and an option 42 for accessing and editing an existing profile. The former generates a webpage 44 for entering information such as name, account number, communication identifier, billing information, and the like. The latter generates a webpage 46 with an option 48 for adding or editing contact information, e.g., the identifiers ID_A-ID_H, and an option 50 for uploading or selecting greetings 14a-14d. Greetings may be obtained from the terminal 38, from the system 10, or from the Internet 12. As information is added and/or modified using the interface 32, the user's profile 20a-20c is updated accordingly and stored in the database 30. Of course, the interface 32 will typically be provided with security features such as password protection for limiting unauthorized access to user profiles.

Referring back to FIG. 1, the database 30 will typically include a number of profiles 20a-20c, each for a different user. For determining which profile 20a-20c to access when a source/caller terminal 16 initiates a communication to a recipient/called terminal 18, the communication identifier ID_1 of the recipient terminal will typically be cross-referenced to the database 30. This may be done by searching the profiles until the profile listing the communication identifier is found, or the database may include a table, list, or other index 36 or the like linking communication identifiers to their respective profiles, which can be searched in a more expeditious manner and the profile thereafter directly accessed. Other standard database configurations are possible.

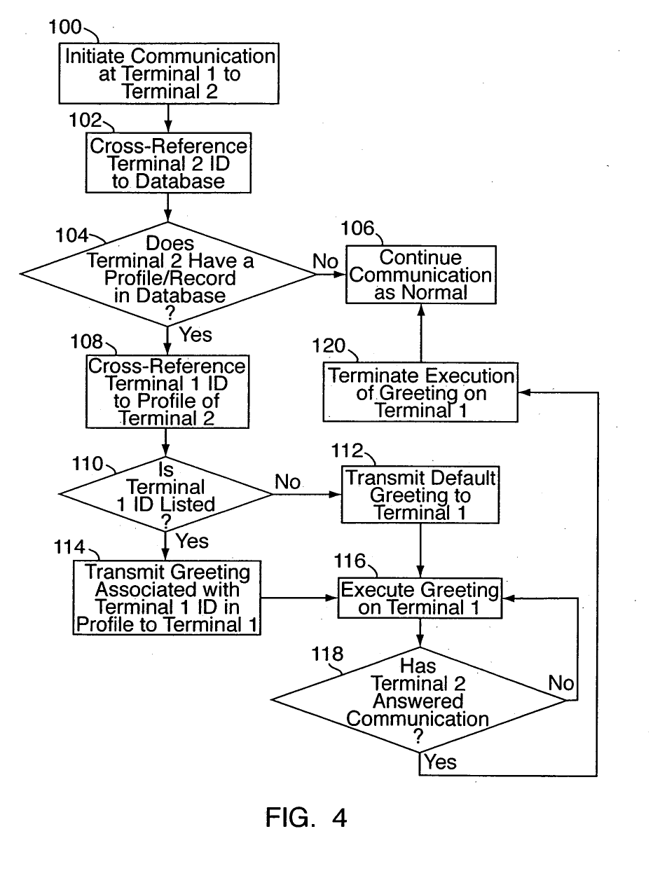

FIG. 4 illustrates the operation of an embodiment of the system 10. At Step 100, a first (source) terminal 16 initiates communication with a second (recipient) terminal 18 in a standard manner. Inherently, this involves the first terminal 16 supplying the communication identifier ID_1 of the second terminal 18 to the network 12. (For example, if the second terminal is a mobile phone, the mobile phone number of the recipient terminal would be entered into the first terminal for contacting the second terminal.) At Step 102, the communication identifier ID_1 is cross-referenced to the database 30, as described above. At Step 104, it is determined whether there is a profile 20a-20c associated with the second/recipient terminal 18, based on the identifier ID_1. If not, at Step 106 the communication continues as it normally would, according to the configuration of the network 12 and terminals 16, 18. If there is a profile associated with the second terminal 18, e.g., profile 20a, at Step 108 the identifier ID_G of the first terminal is cross-referenced to the second terminal's profile 20a. At Step 110, it is determined if the identifier ID_G of the first terminal 16 is listed in the profile 20a. If not, at Step 112 the default greeting or other executable data 14d is transmitted or otherwise provided to the first terminal 16 from the media server. As noted above, the default greeting is a greeting designated for terminals not listed in the profile 20a. If so, at Step 114 the greeting 14c associated with the identifier ID_G of the first terminal 16 in the profile 20a is transmitted or otherwise provided to the first terminal from the media server. As noted, the greeting 14c is a greeting that the user of the second terminal 18 has specifically designated for playing to the first terminal 16 (and possibly other terminals) when the first terminal 16 initiates communication with the second terminal 18. At Step 116, whichever greeting 14c, 14d is transmitted to the first terminal 16, that greeting is automatically executed on the first terminal 16. At Step 118, while the greeting is being played or otherwise executed on the first terminal, it is determined whether the initiated communication has been answered at the second terminal. Until the communication is answered, the greeting is played, at Step 116. Once the communication is answered at the second terminal, execution of the greeting on the first terminal is terminated, as at Step 120, and the communication continues as at Step 106.

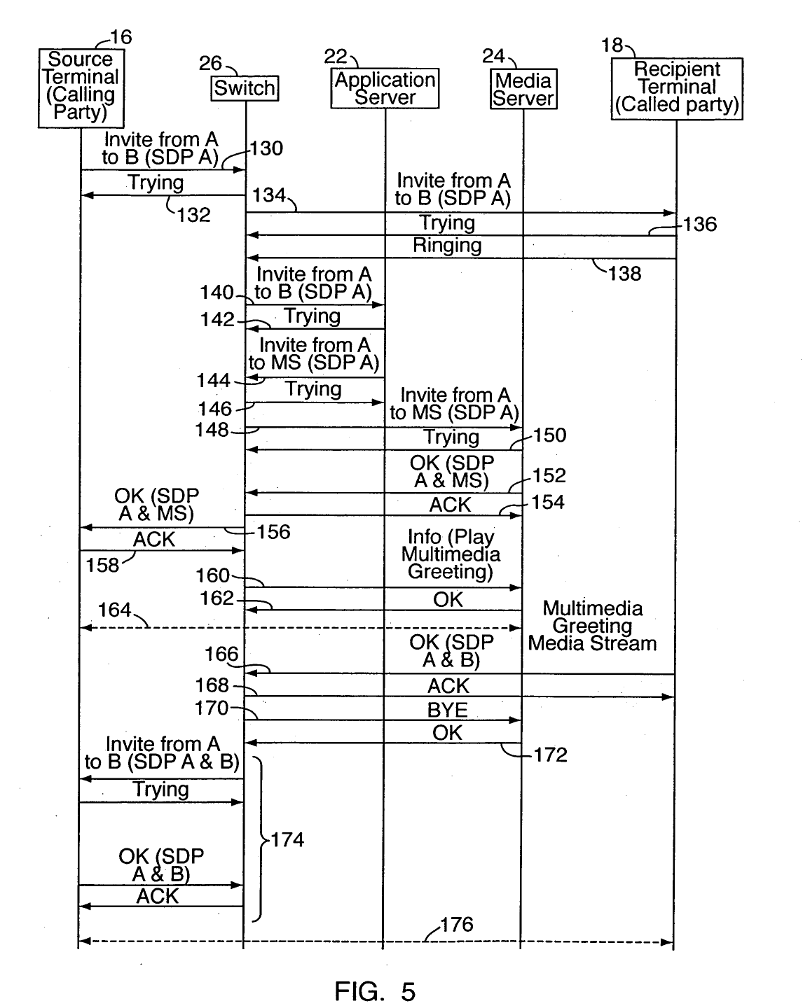

Signal, message, and/or content/data flow between the system components shown in FIG. 1 (e.g., for implementing the functionality described in FIG. 4) will depend in part on the particular components and communication protocols used in the network(s) 12. One embodiment of a scheme for message and content flow for the system 10 is shown in FIG. 5, in the case where SIP (session initiation protocol) is used in the network. At Step 130, the source terminal 16 (e.g., the calling party) initiates a communication with the recipient terminal 18 by sending an “invite” message to the network switch 26. “SDP” refers to the session description protocol, which is a protocol used as an information element in SIP messages, such as describing the media capabilities of a terminal including the transport protocol used, such as ATM or IP, the address of the device, e.g., IP address or ATM address, the audio codec supported, e.g., G711 or G723, the video codec supported, e.g., H.263 or H.264, and the like. At Step 132, the switch 26 sends a “trying” message back to the source terminal 16 to inform the source terminal that the switch is attempting to contact the recipient terminal 18. At Step 134, the switch 26 sends an “invite” message to the recipient terminal 18. At Steps 136 and 138, the recipient terminal 18 acknowledges the “invite” message by sending “trying” and “ringing” messages back to the switch, respectively. At Step 140, the switch 26 contacts the application server 22 by sending an “invite” message to the application server 22, which may include the communication identifiers of both the source terminal and the recipient terminal. The application server 22 responds by sending a “trying” acknowledgement back to the switch 26, as at Step 142. At Step 144, the application server 22 requests that the switch 26 contact the media server 24 by sending an “invite” message, typically along with the file name/identity of the greeting to be transmitted to the source terminal 16. (As should be appreciated, between Steps 142 and 144 the application server cross-references the communication identifier of the recipient terminal to the database/profiles, and, if a profile exists for the recipient terminal, the communication identifier of the source terminal to the recipient terminal's profile. If there is no profile for the recipient terminal, the process may end after Step 142, possibly with a “failure” message or the like back to the switch 26.) At Step 146, the switch 26 may acknowledge this request by sending a “trying” message back to the application server 22.

At Step 148, the switch 26 sends an “invite” message to the media server 24, which includes information relating to the capability of the source terminal to play/execute the greeting or other executable data set/file. The media server 24 may respond with a “trying” message at Step 150, and an “OK” message at Step 152 if the greeting file or other executable data set is found and available to the media server 24 based on the capability information of the source terminal. (In other words, the selection of the greeting file or other executable data set may be based in part on the capability information of the source terminal, including selecting among different versions of the same file, or modifying a file or file format, based on the capabilities of the source terminal. Additionally or alternatively, the application server 22 may be configured to choose a media codec for the executable data supported by both the media server 24 and the source terminal 16.) At Step 154, the switch 26 may send an acknowledgement message back to the media server 24. At Step 156 the switch may send an “OK” message back to the source terminal 16, which may respond with an acknowledgement message at Step 158. Subsequently, at Step 160 the switch 26 sends a command to the media server 24 for the greeting to be transmitted to the source terminal, which includes the file name/identity of the greeting to be transmitted to the source terminal. At Step 162, the media server 24 may respond with an “OK” message. At Step 164, the media server 24 transmits the greeting or other executable data set/file to the source terminal 16.

At Step 166, the recipient terminal 18 answers the initiated communication, e.g., the user of the recipient terminal presses a “call answer” button on the terminal 18. This results in an “OK” message being sent to the switch 26. At Step 168, the switch 26 sends an acknowledgement message back to the recipient terminal 18, and a terminate command to the media server 24 at Step 170. The terminate command instructs the media server 24 to halt transmission of the greeting. At Step 172, the media server may respond with an “OK” message acknowledging the instruction to halt transmission of the greeting. At Step 174, one or more messages may then be sent between the switch 26 and source terminal 16 for completing the communication path between the source terminal and the recipient terminal. At Step 176, the source terminal 16 and the recipient terminal 18 communicate over the network 12 in a standard manner.

As should be appreciated, although the profiles 20a-20c have been shown as being stored on the application server 22, each user's profile could instead be stored locally on the user's terminal, with the system 10 accessing the profile on the terminal when a communication is initiated to the terminal.

Since certain changes may be made in the above-described method for delivering a customized multimedia greeting to a calling party in a communication network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for communicating with at least one terminal over a network, said method comprising the steps of:
comparing a communication identifier of a first terminal to a record associated with a second terminal, upon initiation of a communication from said first terminal to said second terminal; and
initiating transmission of executable data to said first terminal based on said comparison, said data being associated with the first terminal in the record.

2. The method of claim 1 wherein the executable data is multimedia greeting data configured for automatic display on said first terminal.

3. The method of claim 2 further comprising:
terminating display of said greeting data upon said communication being answered at said second terminal.

4. The method of claim 1 wherein:
the record includes a plurality of communication identifiers each having executable data associated therewith; and
the communication identifier of the first terminal is compared to said plurality of communication identifiers for identifying the executable data to be transmitted to the first terminal.

5. The method of claim 4 wherein the executable data is multimedia greeting data configured for automatic display on said first terminal.

6. The method of claim 5 further comprising:
terminating display of said greeting data upon said communication being answered at said second terminal.

7. The method of claim 4 wherein:
the record further includes default executable data; and
the default data is transmitted to the first terminal if the communication identifier of the first terminal is not in said record.

8. The method of claim 7 wherein the default executable data is multimedia greeting data configured for automatic display on said first terminal.

9. The method of claim 8 further comprising:
terminating display of said greeting data upon said communication being answered at said second terminal.

10. The method of claim 1 further comprising:
comparing a communication identifier of said second terminal to a plurality of records to identify said record associated with the second terminal, said plurality of records including said record associated with the second terminal.

11. A method for communicating with at least one terminal in a network, said method comprising the steps of:
determining if a communication identifier of a first terminal is listed in a record associated with a second terminal, upon initiation of a communication from said first terminal to said second terminal; and, if so,
initiating transfer of executable data to said first terminal, said executable data being associated with the first terminal in said record.

12. The method of claim 11 wherein:
the executable data is multimedia greeting data configured for automatic display on the first terminal; and
each of said terminals is a wireless unit.

13. The method of claim 12 further comprising:
terminating display of said greeting data upon said communication being answered at said second terminal.

14. The method of claim 11 further comprising:
initiating transfer of default executable data to said first terminal if said first terminal is not listed in said record.

15. The method of claim 14 wherein the default data is default multimedia greeting data configured for automatic display on the first terminal.

16. The method of claim 15 further comprising:
terminating display of said default greeting data upon said communication being answered at said second terminal.

17. The method of claim 11 further comprising:
comparing a communication identifier of said second terminal to a plurality of records to identify said record associated with the second terminal, said plurality of records including said record associated with the second terminal.

18. A method for delivering multimedia greetings to calling wireless units in a network, said method comprising the steps of:
referencing an identifier associated with a first wireless unit to a record associated with a second wireless unit, said first wireless unit initiating communication with said second wireless unit, wherein the record includes at least one of (i) a default multimedia greeting and (ii) one or more second multimedia greetings associated with at least one communication identifier in said record;
initiating transmission of said default multimedia greeting from a network media server to said first wireless unit if said first wireless unit identifier is not listed in the record; and
initiating transmission of a selected one of said second multimedia greetings from said network media server to said first wireless unit if said first wireless unit identifier is listed in said record, wherein the selected second multimedia greeting is associated with said first wireless unit identifier in the record, and wherein said default multimedia greeting and said one or more second multimedia greetings are configured for automatic playback on said first wireless unit.

19. The method of claim 18 further comprising:
terminating execution of the multimedia greeting transmitted to the first wireless unit upon said communication being answered at said second wireless unit.

20. The method of claim 19 further comprising:
comparing a communication identifier of said second wireless unit to a plurality of records to identify said record associated with the second wireless unit, said plurality of records including said record associated with the second wireless unit.
